(19) United States
(12) Patent Application Publication
(10) Pub. No.: US 2004/0182899 A1
(43) Pub. Date: Sep. 23, 2004

(54) Caddy for use with mobile vehicle

(76) Inventor: Murray L. Deutchman, Barnesville, MD (US)

Correspondence Address: Larson & Associates, P.C., 221 East Church Street, Frederick, MD, 21701-5405, US

(21) Appl. No.: 10/768,372

(22) Filed: Jan. 30, 2004

Related U.S. Application Data
(63) Continuation-in-part of application No. 10/073,191, filed on Feb. 13, 2002, now abandoned.

(51) Int. Cl. B60R 7/00; B60R 9/00

(52) U.S. Cl. 224/410

(57) ABSTRACT

A caddy formed of material and suitable to secure and transport a variety of objects when used with a mobile vehicle is disclosed. Securing devices coupled to the material are operable to temporarily secure one or more of a plurality of objects to the caddy. Attachment devices are operable to removably attach and detach the caddy to the body of the mobile vehicle.

### PRIORITY CLAIM

The instant application is a continuation-in-part application of pending U.S. patent application Ser. No. 10/073,191. Benefit under Title 35, United States Code, Section 120 is claimed.

### FIELD OF THE INVENTION

This invention relates generally to the field of caddies or carriers for objects. More particularly, this invention relates to a caddy suitable for use with a mobile vehicle.

### BACKGROUND

There currently is no way to easily secure and transport tools, implements or materials commonly needed or employed while using a farm tractor, riding mower, all-terrain vehicle, or other such type of mobile vehicle. As is often the case, someone utilizing such a mobile vehicle must carry the tools or implements in their hands or balance them on some part of the mobile vehicle or attach a trailer or cart to the mobile vehicle in order to carry tools and light implements while operating the mobile vehicle. These procedures can be time consuming and inefficient, as well as making driving of the vehicle more difficult and potentially less safe. The attachment of a cumbersome cart can make the vehicle hard to maneuver and may not allow access to tight places. Moreover, the attachment of a cart or trailer by a hitch is hardly an easy or intuitive endeavor and may require expertise, skill, dexterity and time not always found with many users of such mobile vehicles. In light of these difficulties encountered with attaching a hitch, users of mobile vehicles may elect to carry tools by hand or balanced precariously on the hood or body of the vehicle while driving, further degrading safe operation of the vehicle.

### OVERVIEW OF CERTAIN EMBODIMENTS

Objects and features of the invention will become apparent to those of ordinary skill in the art upon consideration of the following detailed description of the invention. In accordance with certain embodiments of the present invention, a caddy is formed of material and suitable to secure and transport a variety of objects when used with a mobile vehicle. Securing devices coupled to the material are operable to temporarily secure one or more of a plurality of objects to the caddy. Attachment devices are operable to removably attach and detach the caddy to the body of the mobile vehicle.

### BRIEF DESCRIPTION OF THE DRAWINGS

The novel features believed characteristic of the invention are set forth in the appended claims. The invention itself, however, as well as the preferred mode of use, and further objects and advantages thereof, will best be understood by reference to the following detailed description of an illustrative embodiment when read in conjunction with the accompanying drawing(s), wherein:

FIG. 1 is an illustration of a caddy with an exemplary arrangement of various securing devices in accordance with certain embodiments of the invention.

FIG. 2 is an illustration of the exemplary caddy of FIG. 1 removably attached to a mobile vehicle in accordance with certain embodiments of the invention.

FIGS. 3-5 are illustrations of a caddy with an exemplary arrangement of various securing and attachment devices in accordance with certain other embodiments of the invention.

FIG. 6 is an illustration of a caddy with exemplary arrangement of various securing and attachment devices in accordance with yet other embodiments of the invention.

FIG. 7 is an illustration of the exemplary caddy of FIG. 6 removably attached to a mobile vehicle in accordance with certain embodiments of the invention.

FIGS. 8-9 are illustrations of a caddy with an exemplary arrangement of various securing and attachment devices in accordance with still other embodiments of the invention.

FIG. 10 is an illustration of the exemplary caddies of FIGS. 8-9 removably attached to a mobile vehicle in accordance with certain embodiments of the invention.

### DETAILED DESCRIPTION

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the description below, like reference numerals are used to describe the same, similar or corresponding parts in the several views of the drawings.

In accordance with certain embodiments of the present invention, a caddy for use with a riding lawn mower, all-terrain vehicle (ATV) or tractor, hereinafter each referred to as a “mobile vehicle,” is provided. The caddy is suitable to secure a variety of items, hereinafter referred to as objects, including but not limited to tools, implements such as hoes, rakes, gardening tools, digging tools, materials such as fertilizers, seeds, chips, etc., measuring devices, schedules, water, refreshments, maps, bags, pouches or carriers for tools, etc. or any other items which may be desirable to and capable of being secured for transportation on the body of a mobile vehicle. Such objects are capable of being temporarily secured in, on or by the caddy by a variety of different ways, such as pockets, hooks, snaps, heavy stitching, clips, hangers, stretch elastic straps (sometimes referred to as “bungee” cords), non-elastic straps, rings, attaching rings, and/or straps, the number, location and construction of which may vary, hereinafter collectively, individually or in combination, referred to as securing devices. Such securing devices are suitable for attaching other, perhaps smaller, securing devices as well, such as smaller bags, pouches, or carriers for tools. As will be clear, a securing device may comprise one or more parts working in combination to provide the functionality of attachment of an object to the caddy. Examples of this would include stretch cords or straps/hooks or hook/loop arrangements.

Appropriate to its use as a carrier of a variety of different objects, such as its use as a tool holder and an implement holder, in accordance with certain embodiments the caddy is accordingly made from heavy-duty material, such as canvas, plastic, metal, a synthetic material such as Cordura®, a registered trademark of E.I. du Pont de Nemours and Company, or other durable material, or combination thereof, sufficient to support the types, quantity and weight, for instance, of the various types of objects secured by securing devices to the caddy. The use of one or more substantially rigid members integral to the material of the caddy reinforce and otherwise buttress the stability and sturdiness of the caddy such that when it is loaded with various objects it does not bunch and maintains its substantially flat form while in use on a mobile vehicle. The one or more substantially rigid members may be made integral to the material of the caddy by heavily stitching them into a pocket in the material or they may otherwise be integrally affixed to the material, such as by heavy-duty glue. Strips or stays of metal such as steel, wood, plastic, nylon, are examples of the one or more substantially rigid members.

While, in accordance with certain embodiments, the material shape of the caddy is substantially rectangular, changes in the shape of the caddy are provided for in the scope of the invention in order that varying shapes of hoods, fenders, etc. of different riding mower, tractor, and other mobile vehicle manufacturers may be accommodated. In this way, the caddy is compatible with many differently designed and manufactured mobile vehicles. The caddy itself rests on a portion of the body of the mobile vehicle, such as on the hood or fender, thereby allowing the operator of the mobile vehicle to transport tools and implements while operating the mobile vehicle. The caddy is capable of being removably attached and detached to the body of the mobile vehicle by utilizing any of a variety of attachment devices, including but not limited to bungee cords, straps, such as elastic-type straps, hook-and-loop, snaps, hooks, or other suitable removable attachment arrangements. Moreover, a portion of the attachment device could include a permanent or attachment fixture (clip, ring, grommet) or hole (in the hood, for instance) of the mobile device itself. Although the caddy is securely attached to the mobile vehicle when the attachment device(s) are engaged, the term removably attached denotes the ability for the user to readily attach, detach or remove the caddy upon demand.

The attachment device may employ a two-part arrangement in which a first part of the attachment device is coupled to the caddy itself and the second, corresponding part of the attachment device is coupled to the body of the mobile vehicle accessible and operable for attachment. When the first and second parts are engagedly coupled to one another, the caddy is removably attached to the body of the mobile vehicle. Examples of such a two-part arrangement may include a bungee cord/grommet arrangement, a hook/loop arrangement, a D-ring/hook arrangement, an elastic strap/“S” hook arrangement, etc. In accordance with certain embodiments of the present invention, the attachment device may be a unitary device coupled to the caddy and operable for attaching to one or more locations of the mobile vehicle. For instance, a flexible strap attached to the caddy in some manner, such as through a grommet, S-hook, stitching or some combination, may be stretched around one or more available surfaces of the mobile vehicle in order to temporarily secure the caddy to it.

As will be described herein, the material of the caddy itself may be a substantially single piece of material, with holes and necessary shaping accommodated, or it may be comprised of two or more pieces of material that operate in harmony to provide the carrier function of the caddy. Either way, accommodations for the venting of the mobile vehicle are provided in accordance with certain embodiments of the present invention.

The caddy eliminates the need to attach a trailer, cart or other transport device in order to carry tools, light implements and other objects while using a mobile vehicle. It solves the problem of how to safely and conveniently transport tools or light implements or other objects when riding on a mobile vehicle while maintaining both hands free to safely operate the mobile vehicle. The caddy employs securing devices to securely hold, secure and transport tools and light implements or other objects, leaving the hands of the operator free to control and steer the mobile vehicle.

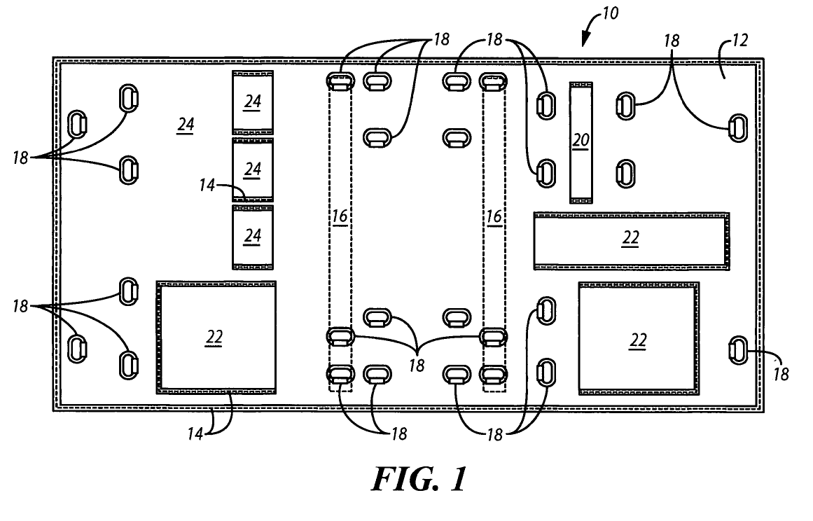

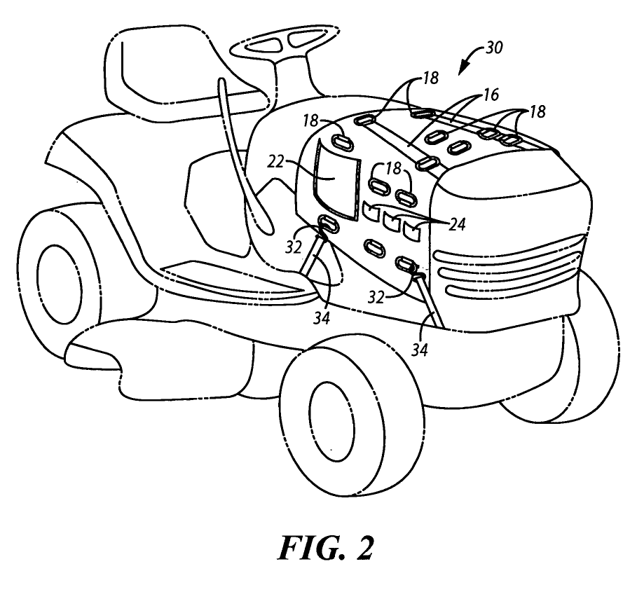

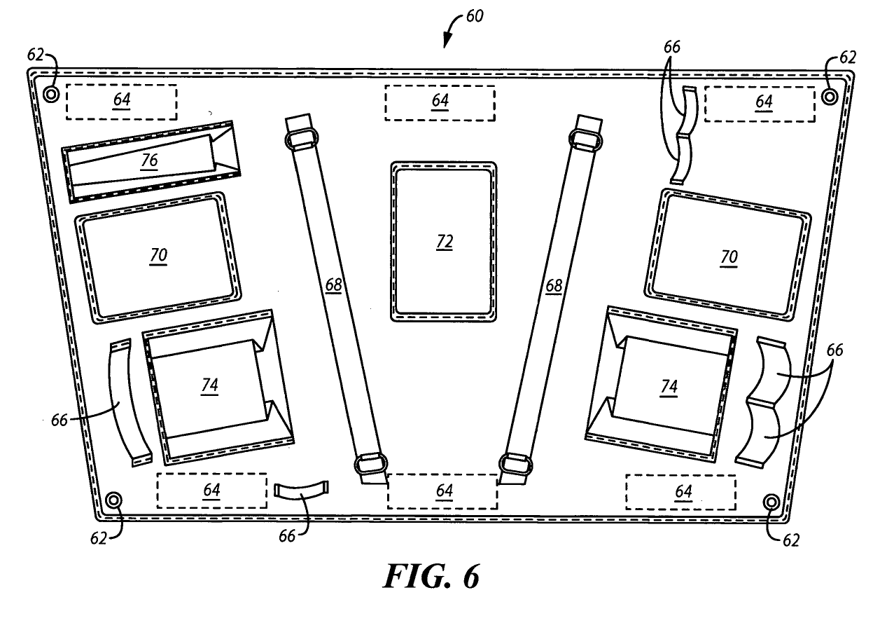

Referring now to FIG. 1, an illustration of a caddy 10 with an exemplary arrangement of various securing devices in accordance with certain embodiments of the invention is shown. In accordance with this exemplary embodiment, the caddy is made from a sheet of heavy canvas 12 having a hemmed edge as shown; leather trim may be used to reinforce the heavy duty stitching 14 of the hem as well as to be aesthetically pleasing. The unitary piece of material from which caddy 10 is made is substantially rectangular in shape, being approximately 18 inches wide by 36″ long, for example. It will be stitched all around the edge 14 to provide a stable piece of material. In accordance with certain embodiments, the caddy will drape across the hood or other appropriate surface of the mobile vehicle and hang down the sides of the hood, as shown in FIG. 2. On the part of the caddy that lies on top of the hood of the mobile vehicle, one or more rigid members 16, such as a metal or other rigid strip, may be sown into the canvas 12 from underneath on the underside portion of the material as indicated by the dashed lines. The rigid strips will run approximately the width of the canvas to provide stability and to prevent the material from bunching as noted previously. As shown in this embodiment, one or more rings 18, such as “D” rings, made of steel or other suitable material, may be attached approximate to one or more of the ends of the rigid members. In this embodiment, at both ends of both rigid member strips 16, on top of the caddy, metal “D” rings 18 are heavy stitched onto the canvas material 12 so that stretch or other straps with “S” hooks or snaps, for example, at each end can attach to the “D” rings 18. It is understood that while such “S” hooks may be employed, other types of hooks and snaps may be used as well. This stretch strap may attach to one of the “D” rings 18 at the end of a rigid strip member 16, pull over the tools and implements (such as a tool box, chain saw, drill, weed trimmer, hand saw, etc.), and attach to a “D” ring 18 at the other end of the rigid strip member 16, or to any other suitable “D” ring 18, or other suitable securing device. The tools, implements or other objects are held in place by the tension or tautness of the straps. The rigid strip members 16 will prevent the canvas sheet 12 from bunching. Where necessary, to accommodate the design of a mobile vehicle manufacturer, ventilation holes will be cut into the material on the top and/or sides of the caddy, as shown in FIGS. 6-10 below.

At various locations around the canvas sheet of material 12, there may be located various securing devices, such as “D” rings 18, holding straps 20, pockets 22 and loops 24 to provide additional locations to attach other tools, implements or other objects with snaps or “S” hooks or other clipping or hooking devices or to provide additional hook locations for the separately provided straps to run across the top of the mobile vehicle or to act as attachment points for other tool pouches or bags.

In the embodiment shown, storage pockets 22 are placed on each side of the caddy on the part that hangs down along the side of the mobile vehicle. The pockets 22 will be large enough to accommodate, nails, staples, bolts or small tools and cans or bottles of beverage, or other objects.

On one side of the caddy where it hangs down the side of the mobile vehicle when in use, short loops 24 are fashioned and heavy stitched to hold tools such as hammers, clippers, or other tools with handles. On the other side of the caddy, pockets of various sizes and shapes may be heavy stitched onto the material, vertically, so that long handled tools, such as rakes, hoes, shovels, etc., can be transported; this is shown in the middle, long shaped pocket on the right side of the figure. An additional horizontal strap 20 is heavy stitched also on the right side of the caddy where gloves or other tools or items needed can be hung or attached for transport. In some cases, pockets or bags of various sizes and shapes will be available as attachments to the securing devices in order to facilitate the carrying of larger tools, implements or objects, including specialty tool boxes, bags, boxes, and hand tools such as a chain saw, hand drill, saw.

The design and location of the various securing devices, such as pockets 22, loops 24, rings 18, etc., may vary from model to model depending on the design or shape of the mobile vehicle. Copies of the individual model designs and shapes may be obtained from the mobile vehicle manufacturer to “custom” make the invention where needed.

Secure attachment of the caddy to the mobile vehicle via one or more attachment devices is important. Referring now to FIG. 2, an illustration 30 of an exemplary caddy removably attached to a mobile vehicle in accordance with certain embodiments of the invention is given. In this illustration, a caddy removably attached to a tractor is shown. The caddy is removably attached to the mobile vehicle by stretch straps 34 with “S” hooks 32 at the ends, in this example. The “S” hooks will attach to the invention at “D” rings 18 located at the bottom of the sides of the caddy that hang down the sides of the mobile vehicle; attachment devices such as grommets may be substituted for these “D” rings. The stretch straps 34 may then be attached to the bottom of the hood of the mobile vehicle, for example, or to vent slits on the mobile vehicle as shown or to any part of the mobile vehicle to which the “S” hooks can attach. If no such parts or locations exist, then small holes can be drilled into a lower area of the side of the tractor on each side to accommodate the “S” hooks or other attachment devices. Various sizes and sufficient numbers of stretch straps 34 can be provided with the caddy to allow for secure attachment of the caddy to the mobile vehicle via the attachment devices.

As previously noted, in order to accommodate design differences in mobile vehicles, the actual shape of the caddy may have to be modified and the location of the securing and attachment devices or pockets changed, depending on the manufacturer's design of the hood or other surface area of the mobile vehicle, but the basic physical components of the invention will be the same and the purposes for which it was designed will be served.

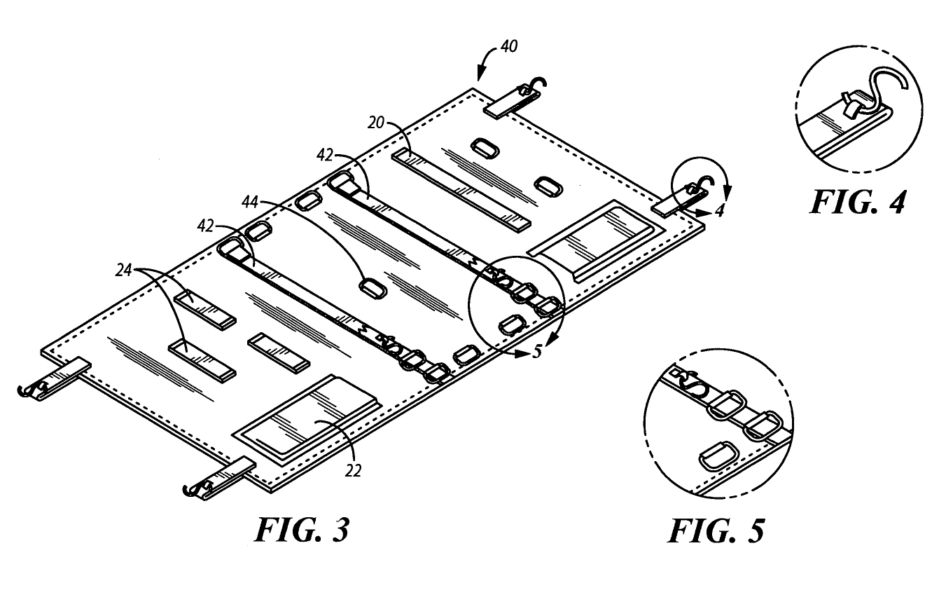

Yet another configuration of the caddy, in accordance with certain embodiments of the present invention, is illustrated in FIG. 3. In this configuration, a slightly different arrangement of securing devices is shown, their arrangement, however, falls within the spirit and scope of the invention. In this embodiment, elastic straps 42 may optionally be placed over the rigid members 16 to facilitate the attachment of even more objects to the caddy. “D” rings 44 can be used to hang the caddy when not in use if desired. Detail “5”, shown in FIG. 5, illustrates that steel “D” rings may be used to hang or otherwise secure tools as needed. Detail “4,” illustrated in more detail in FIG. 4, shows that elastic securing straps with “S” hooks may be employed along the perimeter of the caddy, as shown, as attachment devices to attach the caddy to the mobile vehicle. This is an example of an attachment device having two parts; the first part in this example is the elastic strap coupled to the caddy itself and the second part is the “S” hook for attachment to the mobile vehicle. When the first and second parts are engagedly coupled to one another, the caddy is removably attached to the body of the mobile vehicle. Of course, it is understood that while the use of “S” hooks is provided in this example they are by way of example, and not limitation, of attachment devices. Other attachment devices, previously delineated are also equally applicable with the present invention.

In accordance with yet other embodiments of the present invention, refer to configuration 60 of FIG. 6. In this particular exemplary configuration, different embodiments of securing devices and attachment devices, as well as venting devices, are illustrated. Grommets 62, particularly when used in conjunction with flexible or stretch straps and “S” or other hooks, are well adapted as an attachment device for removably attaching the caddy to a mobile vehicle. An alternate attachment means is provided via hook/loop devices 64 strategically arranged about the perimeter of the caddy to the underside of the caddy; the dotted lines shown indicate their attachment to the underneath of the caddy. Corresponding hook/loop devices may be affixed to the body of the mobile vehicle. When the devices 64 are mated up with the corresponding devices on the vehicle, the caddy is removably attached to the vehicle. A variety of loop or strap securing devices 66 of various sizes are placed about the surface of the caddy to facilitate the securing of various sized objects to the caddy. Other securing devices shown include pockets 76, accordion in style and of various sizes to accommodate different types of tools or other objects. Rigid members 68, such as a metal brace or bar, are affixed inside the caddy material at an angle as shown. The angle facilitates the cover laying flat over the vehicle hood and sides, without bunching, and thus promotes a better fit.

This configuration of the caddy accommodates any air vent design of the manufacturer of the mobile vehicle even while using the caddy. Side vent devices 70 and center vent devices 72 are located to accommodate airflow design of the manufacturer of the mobile vehicle and promote venting from the top and sides of the vehicle when the caddy is in place on the vehicle. Side and/or center vent devices can be selectively used and both types of venting devices are not required by the invention. The venting devices may be open holes cut out in the material of the caddy but it has been found that the covering of the vent with mesh or other breathable material allows for airflow and thus breathability and venting while also protecting the engine of the vehicle from debris or other foreign objects.

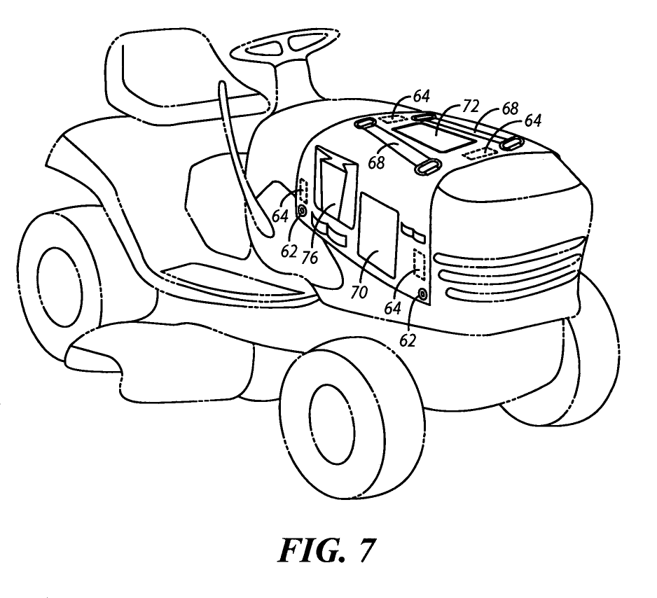

FIG. 7 is an illustration that shows the placement of caddy 60 onto a mobile vehicle, such as a riding lawnmower. The relationship of side and center vent devices 70 and 72 vis-a-vis the vehicle when the caddy is in use is illustrated.

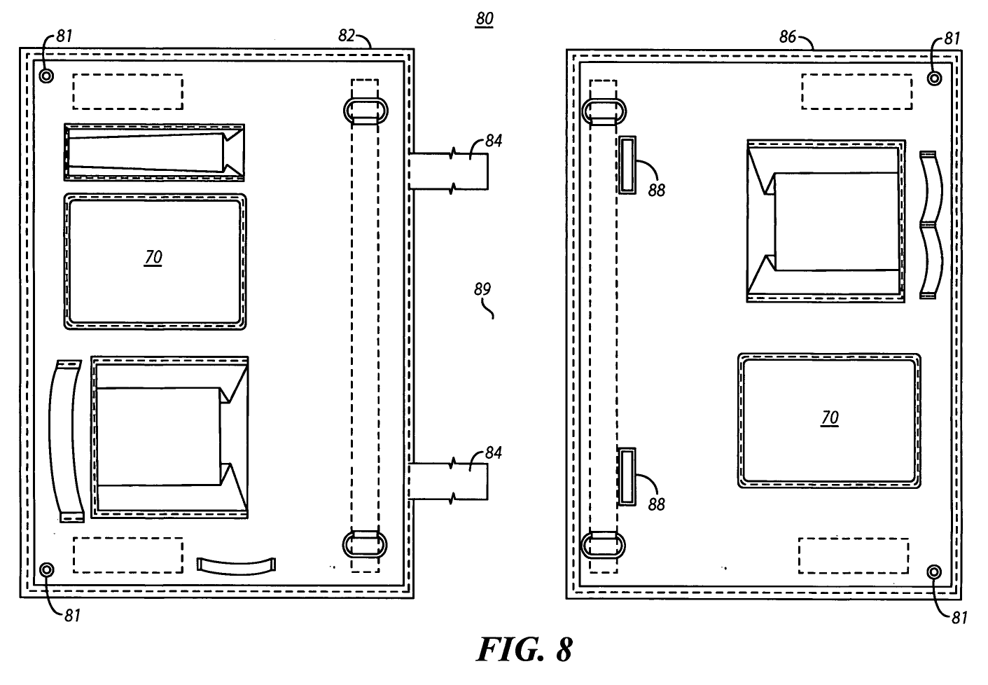

As previously discussed, the caddy may be made of more than a unitary piece of material. Referring now to FIGS. 8-10, configurations of caddies comprising multiple material pieces are illustrated. These approaches provide the advantage of providing a rather large center venting area. It also easily allows the size of the caddy to be dynamically and readily adjusted to fit a variety of various mobile vehicle sizes and shapes.

Referring now to FIG. 8, a two-part configuration 80 of a caddy is illustrated. A first piece 82 of caddy is illustrated on the left side of the figure while a second piece 86 is illustrated on the right side. Parts 82 and 86 are coupled to one another by one or more self-attachment devices, illustrated as hook and look straps 84 and corresponding holes 88. A strap 84 is threaded through the corresponding hole 88 and then looped back onto itself; the hook-and-loop strap is self-sticking. It is recognized that other forms of self-attachment devices may be employed, such as an elastic strap and “S” hook combination suitable for securing to hole 88. Once thus coupled and then placed over the hood or top of a mobile vehicle, first and second parts drape over the sides of the vehicle as shown in FIG. 10. The grommets 81 or other first suitable attachment device are employed, in combination with a corresponding second attachment device coupled to the vehicle, to removably attach the caddy to the mobile vehicle.

Each side part 82 and 86, in this embodiment, has a side vent device; it is noted that the placement of the side vents may change without departing from the scope of the invention and, indeed, it can be seen that their placement is different than that illustrated in FIG. 6, for instance. While there is not a discrete center vent device as in FIGS. 6 and 7, FIGS. 8-10 illustrate the presence of a center vent device 89 region formed by the space between the first and second parts 82 and 86 when these parts are self-attached as shown and described. The center vent device region operates to facilitate air circulation or venting around the hood of the mobile vehicle as described.

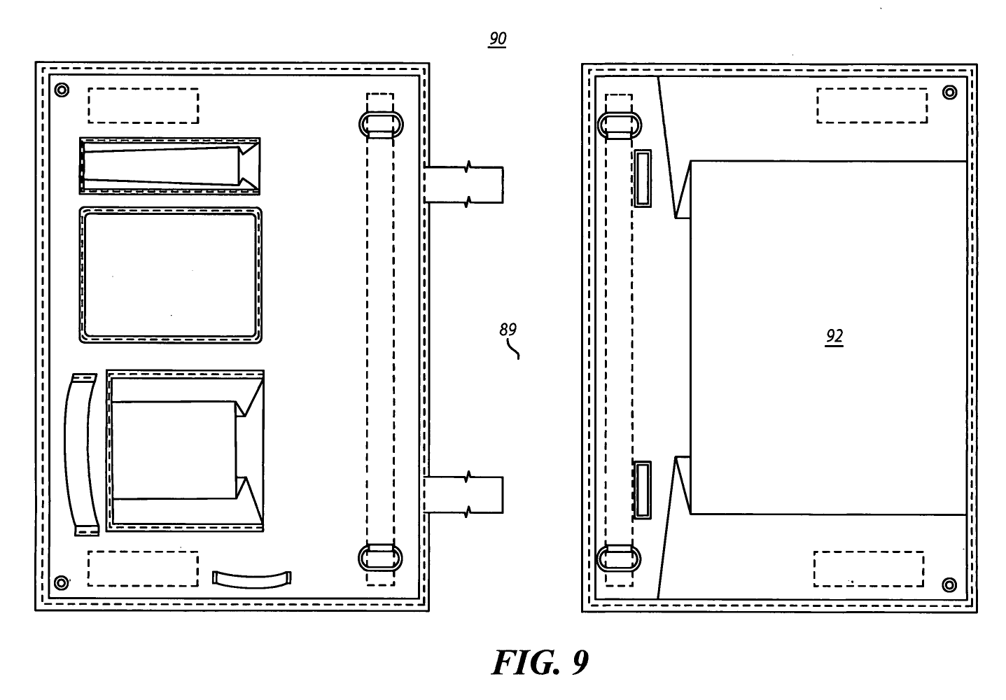

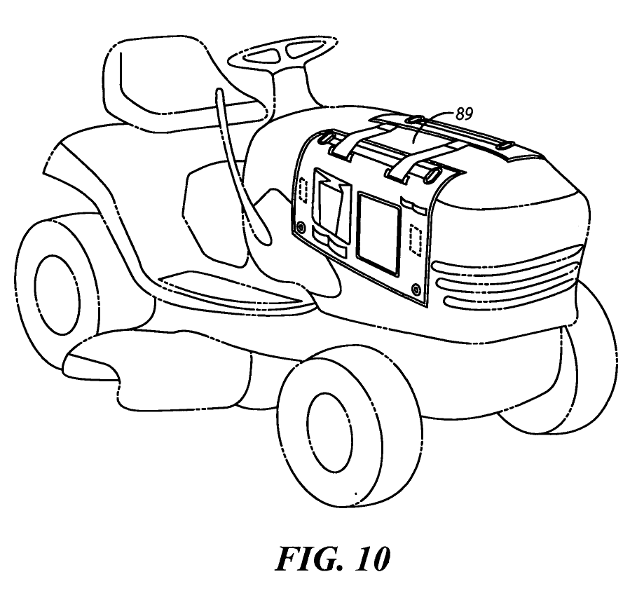

FIG. 9 illustrates a very large pocket as a further example of a type of securing device that may be used. Such a large pocket would accommodate very large tools or containers for transport.

Again, the various placements of the securing and attachment devices in the figures discussed above reinforces that the present invention provides for much flexibility without departing from the spirit and scope of the invention.

Those of ordinary skill in the art will recognize that the present invention has been described in terms of exemplary embodiments. While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims. In particular, the use of canvas material and certain attachment and securing devices in the exemplary embodiments should not be limiting, being by way of example, and not limitation.

What is claimed is:

1. A caddy formed of material and suitable to secure and transport of variety of objects when used with a mobile vehicle, comprising:
a plurality of securing devices operable to temporarily secure one or more of a plurality of objects to the caddy; and
one or more attachment devices operable to removably attach and detach the caddy to the body of the mobile vehicle.

2. The caddy of claim 1, wherein the material of the caddy is a substantially single piece of material.

3. The caddy of claim 1, wherein the material of the caddy comprises a plurality of pieces of material.

4. The caddy of claim 1, wherein the material is one or more of canvas, plastic, metal, synthetic.

5. The caddy of claim 1, wherein the shape of the material is substantially rectangular.

6. The caddy of claim 1, wherein when in use, the caddy rests on a portion of the body of the mobile vehicle.

7. The caddy of claim 1, wherein an attachment device of the one or more attachment devices further comprises:
a first attachment part operatively coupled to the caddy; and
a second attachment part operatively coupled to the mobile vehicle,
wherein when the first and second attachment parts are engagedly coupled the caddy is removably coupled to the mobile vehicle.

8. The caddy of claim 7, wherein the first attachment part comprises one or more first hook and loop portions coupled to the caddy and the second attachment part comprises one or more corresponding second hook and loop portions coupled to the mobile vehicle, wherein the first and second attachment parts are engagedly coupled when the one or more first hook and loop portions are mated to the one or more corresponding second hook and loop portions.

9. The caddy of claim 7, wherein the first attachment part comprises one or more grommets of the caddy and the second attachment part comprises one or more corresponding straps coupled to the mobile vehicle, wherein the first and second attachment parts are engagedly coupled when the one or more corresponding straps are coupled to the one or more grommets.

10. The caddy of claim 9, wherein the second attachment part further comprises one or more hooks operable to engage the one or more grommets of the caddy.

11. The caddy of claim 9, wherein the one or more corresponding straps of the second attachment part comprises one or more stretch straps.

12. The caddy of claim 11, wherein the one or more hooks comprise one or more “S” hooks.

13. The caddy of claim 9, wherein the first attachment part comprises one or more rings of the caddy and the second attachment part comprises one or more hook and strap combinations coupled to the mobile vehicle, wherein the first and second attachment parts are engagedly coupled when the one or more hook and strap combinations are hooks to the one or more rings of the caddy.

14. The caddy of claim 13, wherein the one or more rings further comprise one or more “D” rings.

15. The caddy of claim 13, wherein the one or more hook and strap combinations further comprise one or more stretch straps.

16. The caddy of claim 1, wherein the caddy further comprises:
one or more substantially rigid members integral to the material operable to reinforce the material and contribute to a substantially flat form of the caddy when used with the mobile vehicle.

17. The caddy of claim 16, wherein the one or more substantially rigid members are comprised of one or more of steel, wood, plastic, and nylon.

18. The caddy of claim 16, wherein the one or more substantially rigid members are heavily stitched into one or more corresponding pockets in the material.

19. The caddy of claim 16, wherein the one or more substantially rigid members are glued to the material.

20. The caddy of claim 1, wherein the caddy further comprises:
one or more vent devices to accommodate airflow to the mobile device when the caddy is used on the mobile device.

21. The caddy of claim 20, wherein the one or more vent devices comprise one or more of a side vent device operable to be positioned over a side portion of the body of the mobile vehicle and a center vent device operable to be positioned over a center portion of the body of the mobile vehicle when the caddy is placed on the mobile vehicle.

22. The caddy of claim 20, wherein the one more vent devices are formed from holes cut into the material of the caddy.

23. The caddy of claim 20, wherein the material of the caddy comprises a plurality of pieces of material and a center vent device of the one or more vent devices are formed by an opening between the plurality of pieces of material.

24. The caddy of claim 23, wherein a side vent of the one or more vent devices are formed from holes cut into the material of the caddy.

25. The caddy of claim 20, wherein the one or more vent devices are covered with a breathable material.

26. A caddy formed of material and suitable to secure and transport of variety of objects when used with a mobile vehicle, comprising:
a first piece of material;
a second piece of material;
one or more self-attachment devices, wherein the first and second pieces of material are operable to be coupled to and detached from one another by the one or more self-attachment devices;
a plurality of securing devices operable to temporarily secure one or more of a plurality of objects to the caddy and coupled to one or more of the first and second pieces of material; and
one or more attachment devices operable to removably attach and detach the caddy to the body of the mobile vehicle and coupled to one or more of the first and second pieces of material.

27. The caddy of claim 26, wherein a self-attachment device of the one or more self-attachment devices comprises:
a strap coupled to the first piece of material; and
a corresponding hole in the second piece of material, wherein the first and second pieces of material are coupled together when the strap is placed through the corresponding hole and secured.

28. The caddy of claim 27, wherein the strap is a hook and loop strap that self-secures after being placed through the corresponding hole.

29. The caddy of claim 26, wherein the caddy further comprises:
one or more vent devices to accommodate airflow to the mobile device when the caddy is used on the mobile device.

30. The caddy of claim 29, wherein the one or more vent devices comprise one or more of a side vent device operable to be positioned over a side portion of the body of the mobile vehicle and a center vent device operable to be positioned over a center portion of the body of the mobile vehicle when the caddy is placed on the mobile vehicle.

31. The caddy of claim 29, wherein the one more vent devices are formed from holes cut into the material of the caddy.

32. The caddy of claim 29, wherein the center vent device is formed by a space between the first and second pieces of material when coupled together by the one or more self-attachment devices.

33. The caddy of claim 32, wherein a side vent of the one or more vent devices are formed from holes cut into the material of the caddy.

34. The caddy of claim 29, wherein the one or more vent devices are covered with a breathable material.

35. The caddy of claim 26, wherein an attachment device of the one or more attachment devices further comprises:
a first attachment part operatively coupled to the caddy; and
a second attachment part operatively coupled to the mobile vehicle,
wherein when the first and second attachment parts are engagedly coupled the caddy is removably coupled to the mobile vehicle.

36. The caddy of claim 35, wherein the first attachment part comprises one or more first hook and loop portions coupled to the caddy and the second attachment part comprises one or more corresponding second hook and loop portions coupled to the mobile vehicle, wherein the first and second attachment parts are engagedly coupled when the one or more first hook and loop portions are mated to the one or more corresponding second hook and loop portions.

37. The caddy of claim 35, wherein the first attachment part comprises one or more grommets of the caddy and the second attachment part comprises one or more corresponding straps coupled to the mobile vehicle, wherein the first and second attachment parts are engagedly coupled when the one or more corresponding straps are coupled to the one or more grommets.

38. The caddy of claim 37, wherein the second attachment part further comprises one or more hooks operable to engage the one or more grommets of the caddy.

39. The caddy of claim 38, wherein the one or more corresponding straps of the second attachment part comprises one or more stretch straps.

40. The caddy of claim 39, wherein the one or more hooks comprise one or more “S” hooks.

41. The caddy of claim 35, wherein the first attachment part comprises one or more rings of the caddy and the second attachment part comprises one or more hook and strap combinations coupled to the mobile vehicle, wherein the first and second attachment parts are engagedly coupled when the one or more hook and strap combinations are hooks to the one or more rings of the caddy.

42. The caddy of claim 41, wherein the one or more rings further comprise one or more “D” rings.

43. The caddy of claim 41, wherein the one or more hook and strap combinations further comprise one or more stretch straps.

44. The caddy of claim 26, wherein the caddy further comprises:
one or more substantially rigid members integral to the material operable to reinforce the material and contribute to a substantially flat form of the caddy when used with the mobile vehicle.

45. A caddy formed of material and suitable to secure and transport of variety of objects when used with a mobile vehicle, comprising:
a first piece of material;
a second piece of material;
one or more self-attachment devices, wherein the first and second pieces of material are operable to be coupled to and detached from one another by the one or more self-attachment devices;
a plurality of securing devices operable to temporarily secure one or more of a plurality of objects to the caddy and coupled to one or more of the first and second pieces of material;
one or more attachment devices operable to removably attach and detach the caddy to the body of the mobile vehicle and coupled to one or more of the first and second pieces of material;
one or more of a side vent device and a center vent device to accommodate airflow to the mobile device when the caddy is used on the mobile device, wherein the center vent device is formed by a space between the first and second pieces of material when coupled together by the one or more self-attachment devices; and
one or more substantially rigid members integral to the first and second pieces of material operable to reinforce the material and contribute to a substantially flat form of the caddy when used with the mobile vehicle.

46. The caddy of claim 45, wherein the side vent device is operable to be positioned over a side portion of the body of the mobile vehicle and the center vent device operable to be positioned over a center portion of the body of the mobile vehicle when the caddy is placed on the mobile vehicle.

47. The caddy of claim 45, wherein the side vent device is formed from a hole cut into the material of the caddy.

48. The caddy of claim 45, wherein the one or more vent devices are covered with a breathable material.

49. The caddy of claim 45, wherein a self-attachment device of the one or more self-attachment devices comprises:
a strap coupled to the first piece of material; and
a corresponding hole in the second piece of material, wherein the first and second pieces of material are coupled together when the strap is placed through the corresponding hole and secured.

50. The caddy of claim 49, wherein the strap is a hook and loop strap that self-secures after being placed through the corresponding hole.
